(19) United States
(12) Patent Application Publication
(10) Pub. No.: US 2023/0237441 A1
(43) Pub. Date: Jul. 27, 2023

(54) SYSTEMS, METHODS AND COMPUTER PROGRAM PRODUCTS FOR MANAGING AND NETWORKING SCHEDULES AND CALENDARS OF EVENTS

(71) Applicant: Peter Larsen, Arlington, VA (US)

(72) Inventor: Peter Larsen, Arlington, VA (US)

(73) Assignee: WhensIt LLC, Arlington, VA (US)

(21) Appl. No.: 18/088,598

(22) Filed: Dec. 25, 2022

Related U.S. Application Data
(60) Provisional application No. 63/302,289, filed on Jan. 24, 2022.

(51) Int. Cl. G06Q 10/1093

(52) U.S. Cl. CPC G06Q 10/1095

(57) ABSTRACT

Systems, methods, and computer program products for managing and networking schedules and calendars of events are provided herein. A method of a managing, networking, and presenting calendars, schedules and events can include uploading from one or more computing devices of one or more users at least one of calendars of events, schedules of events or individual events to a scheduling event networking system. The method can also include grouping two or more calendars of events, schedules of events or individual events into one or more umbrella groupings based on instructions received from one or more computing devices of one or more users. The method can further include displaying on one or more computing devices of one or more users a layered network of one or more of the calendars of events, schedules of events, individual events, or umbrella groupings on the scheduling event networking system based on user preferences.

### TECHNICAL FIELD

The present subject matter relates generally to systems, methods, and computer program products for managing and networking schedules and calendars of events. In particular, the present subject matter relates systems, methods, and computer program products, including but not limited to software applications and mobile applications for event, calendar, and schedule display, networking, and management.

### BACKGROUND

Currently, schedules and calendars of events are housed on multiple venues and platforms such as email media, print media, and various web site posts. Individuals must search through numerous sites to find events that are important or of interest to the individual—an exercise which can take an excessive amount of time. For example, an individual may spend a great deal of time to find the academic calendar for a particular high school or university, add an event of interest to a personal calendar with a separate application, and then repeat the process for other schedules and calendar events of interests such as movie show times, religious services, and youth sporting events. Current methods of schedule and calendar event data storage and presentation are inefficient in large part due to a lack of a common repository of networked schedules and calendars and events. Advancements in mobile processing devices, allow for internet-based tools to network a variety of organization and individual calendars and schedules of events. However, existing systems or methods do not link, network, and nest schedules and calendars of various organizations in a common application platform. Also, current methods and systems do not allow users of mobile devices to seamlessly observe previously unlinked but topically related calendars and schedules of events using a single method, system, or mobile application. Furthermore, existing systems and methods do not allow a plurality of owners of calendars and schedules of events to build networks of calendars and schedules of events with a plurality of other owners of calendars and event schedules into thematically or user defined nested architectures that are efficiently browsed by other users on a single mobile device application.

As such, a need exists for improved event calendaring and scheduling management, networking and display that allow users to easily create and access a network of a plurality of calendar or schedules of events of interest to users.

### SUMMARY

The present disclosure relates generally to a system, method, and mobile application for event, calendar and schedule networking and display. In particular, the present subject matter relates systems, methods, and computer program products, including but not limited to software applications and mobile applications for event, calendar, and schedule display, networking, and management.

The present subject matter also relates to computer program products for managing, networking, and displaying calendars and schedules of events of organizations, entities, and individual users by the organizations, entities, and individual users. The subject matter described herein may be implemented in software, in combination with hardware and/or firmware. For example, the subject matter described herein may be implemented in software executed by a hardware-enabled processor. In one exemplary implementation, the subject matter described herein displaying, networking, and managing calendars and schedules of events of organizations, entities, and individual users by the organizations, entities, and individual users may be implemented using one or more non-transitory computer readable mediums having stored thereon executable instructions that when executed by the processor of a computer control the processor to perform steps. Exemplary non-transitory computer readable media suitable for implementing the subject matter described herein include chip memory devices or disk memory devices accessible by a processor, programmable logic devices, and application specific integrated circuits. In addition, a computer readable medium that implements the subject matter described herein may be located on a single computing platform or may be distributed across plural computing platforms. Further, it should be noted that the systems and methods utilize and can comprise communication systems and devices and their components and functionality described herein. These communication systems and devices constitute special purpose devices that improve the technological field of providing communication connections for and/or mechanisms for managing, networking, and presenting calendars, schedules, and events.

Thus, it is an object of the presently disclosed subject matter to provide systems, methods, and computer program products for managing and networking schedules and calendars of events. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 illustrates a diagram of an environment for implementing a schedule and calendar network system in accordance with one or more embodiments;

FIG. 2 illustrates a block diagram of components of a schedule and calendar network system in accordance with one or more embodiments;

FIGS. 3a-3b illustrate, in an embodiment, exemplary process diagrams of users interacting with schedule networking system;

FIGS. 4a-4b illustrate, in an embodiment, exemplary process diagrams of users interacting with schedule networking system;

FIGS. 5a-5d are representations, in an embodiment of an exemplary mobile application; and

FIG. 6 illustrates a diagram of a network of community schedules and calendars in accordance with one or more embodiments.

Repeat use of reference characters in the present specification and drawings is intended to represent the same or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. Thus, it is intended that the present subject matter cover such modifications and variations as come within the scope of the appended claims and their equivalents. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back, etc. may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer, or section. Thus, a first feature, element, component, region, layer, or section discussed below could be termed a second feature, element, component, region, layer, or section without departing from the teachings of the disclosure herein.

Embodiments of the subject matter of the disclosure are described herein with reference to schematic illustrations of embodiments that may be idealized. As such, variations from the shapes and/or positions of features, elements, or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted, or simplified to facilitate explanation of the subject matter disclosed herein. Thus, the features, elements or components illustrated in the figures are schematic in nature and their shapes and/or positions are not intended to illustrate the precise configuration of the subject matter and are not intended to limit the scope of the subject matter disclosed herein.

“Computing device(s),” as used herein means one or more desktop computers, laptop computers, set-top devices, tablet computers, handheld devices, mobile devices, mobile smart devices, smartphones, wearable devices, servers, interactive vehicle computers, and/or the like and includes, but is not limited to any mobile electronic device configured with imaging and/or computing capabilities. Such computing devices can include, but are not limited to, at least one of a mobile smartphone, a personal digital assistant (PDA), a computing tablet, a personal media player, vehicle computer with interactive capabilities, or any like mobile electronic device configured with imaging and/or computing capabilities. In some embodiments, the computing device may be provisioned with a hardware-based processor that is configured to execute software programs or applications.

“Software,” “software application,” “mobile application,” and/or “application” as used herein means a computer program product for and used on a computing device that can be in the form of one or more non-transitory computer readable media comprising computer executable instructions embodied in a computer readable medium that when executed by a processor of a computer can control of the computer such that the computer can perform specific steps.

The present disclosure relates generally to systems, methods, and mobile applications for event, calendar and schedule networking and display. In one aspect, a system and/or method can be provided to enable organizations, such as religious institutions, schools, youth and professional sports teams, universities, clubs, entertainment venues, entertainers, individuals, or the like, to link and create networks of calendars and schedules or events in a way that users interested in said calendars and event schedules can efficiently retrieve information, dates, and times of events. Application programming interfaces (API) can then be used to synchronize user chosen events within the user's mobile device calendar and browse the calendars or event schedules of different organizations that are thematically nested. The system or method provides a means for otherwise unlinked calendars and schedules of events, organizations, entities to link and nest if the owners of calendars and schedules of events mutually agree to link or nest their respective calendars. For users of the application, the system or method provides a common platform to easily access a variety of schedules and calendars, regardless of whether a user posts scheduling content to the system.

In another aspect, the application can improve on existing systems or methods by enabling each owner of a schedule or calendar of events to not only have the option to display publicly the owner's schedule or calendar of events and associated information to all users of the mobile application, but also to request of other organizations to be nested within the other organizations' umbrellas or arrays of calendars and event schedules, thereby creating useful and thematically linked networks of calendars and schedules of events. A user of the systems, methods or mobile applications can efficiently browse nested calendars and event schedules. A particular calendar or schedule of events may be under multiple thematic umbrellas and networked to multiple calendars and schedules of events. For example, a service organization at a university may be linked to said university's umbrella grouping of schedules and calendars of events but also linked to the local town's umbrella grouping of schedules and calendars of events and also to an umbrella grouping of schedules and calendars of events created by a national syndicate of the service organization. Furthermore, in an aspect, a user of the system or method described herein could link private schedules and calendars, with restricted access, to a network of other public and private schedules and calendars.

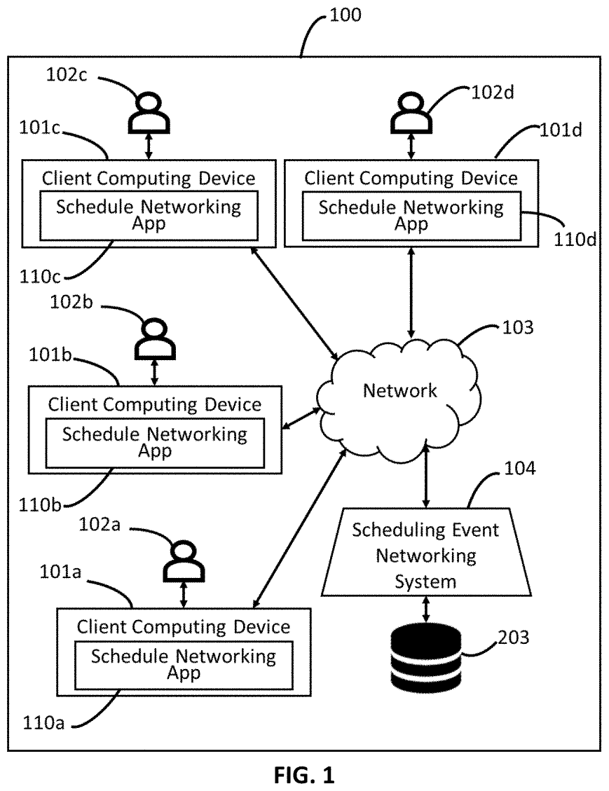

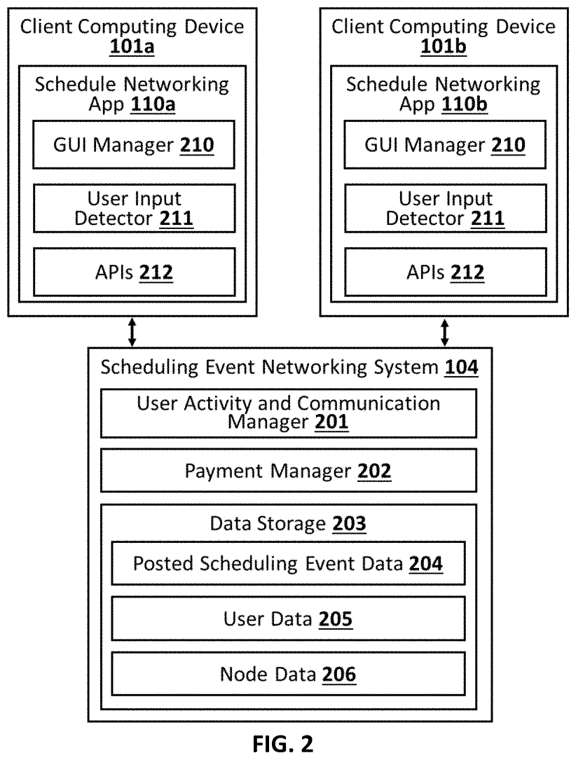

FIG. 1 illustrates an example diagram of event schedule networking system 100 (or simply “system 100”). As illustrated in FIG. 1, in an embodiment, the system 100 may include client computing devices 101a, 101b, 101c and 101d, and a scheduling event networking system 104, which are amalgamated through a network 103. The scheduling event networking system 104 may include data storage 203. Also as illustrated, in FIG. 1, users 102a, 102b, 102c and 102d may interact with client computing devices 101a, 101b, 101c and 101d respectively to access scheduling event content on scheduling event networking system 104. Furthermore, each of the client computing systems 101a, 101b, 101c and 101d may include a schedule networking application 110a, 110b, 110c, and 110d, respectively, which will be described below with greater detail with reference to FIG. 2.

The client computing devices 101a, 101b, 101c and 101d and the scheduling event networking system 104 can communicate via the network 103, which may include one or more networks and may use one or more communication platforms or technologies capable of transmitting data. In one or more embodiments, the network 103 may include the Internet or World Wide Web. The network 103, however, can include various other types of networks that can use various technologies, such as a virtual private network (VPN), a local area network (LAN), a wireless local network (WLAN), a cellular network, a wide area network (WAN), a metropolitan area network (MAN), or a combination of such networks.

As shown in FIG. 1, the system 100 can include users 102a, 102b, 102c and 102d. The users 102a, 102b, and 102c may be individuals (i.e., human users), businesses, groups, and other entities. Although FIG. 1 illustrates four users, 102a, 102b, 102c and 102d, it is understood that the system 100 can include any plurality of users, with each of the plurality of users interacting with the system 100, through a corresponding plurality of client computing devices.

With reference to the system 100 described herein, any of the users 102a, 102b, 102c and 102d may be able to send and add scheduling event data to the scheduling event networking system 104 or access scheduling event data from the system 104. In some instances, respective scheduling event data owners, which may include any or all of the users 102a, 102b, 102c and 102d, may restrict access to their posted scheduling event data to other users of the system 100. In such an embodiment, the scheduling event networking system 104 would give the respective scheduling event data owners, which may be provided to any or all of users 102a, 102b, 102c and 102d, the option to create private event scheduling networks.

The client computing devices 101a, 101b, 101c and 101d may include various types of computing devices. For example, the client computing devices 101a, 101b, 101c and 101d can include a mobile device such as a mobile telephone, a smartphone, a PDA, a tablet, a laptop, or a non-mobile device such as a desktop, a server, or another type of computing device. Further, the client computing devices 101a, 101b, 101c and 101d may run dedicated schedule networking applications 110a, 110b, 110c, and 110d associated with scheduling event networking system 104. In turn, the scheduling event networking system 104 may present information and content to the users 102a, 102b, 102c and 102d via the schedule networking applications 110a, 110b, 110c, and 110d by way of one or more networking pages (e.g., webpages or pages/views of a mobile application).

In addition, and as shown in FIG. 1, the system 100 can include the scheduling event networking system 104. One or more computing devices executing instructions to perform the processes and provide the features disclosed herein may implement the networking system 104. For example, one or more server devices may implement and/or provide features associated with the scheduling event networking system 104. Additionally, in some embodiments, the scheduling event networking system 104 may be partially implemented by one or more of the client computing devices 102a, 102b, 102c and 102d.

The scheduling event networking system 104 can also provide scheduling event posts to a networking graphical user interface (e.g., a profile, feed, or “wall”) of one more users of the scheduling event networking system 104. For example, one or more embodiments may present a user 102a, 102b, 102c and 102d with scheduling event data updates from co-users associated with the user 102a, 102b, 102c and 102d via the scheduling event networking system 104. In one or more embodiments, each user 102a, 102b, 102c and 102d may scroll through the event schedule updates and posts via the scheduling event networking system 104. In one embodiment, the scheduling event network system 104 may organize the scheduling event posts thematically. In another embodiment, scheduling event network system 104 may organize scheduling event posts chronologically. In alternate embodiments, the scheduling event network system 104 may organize scheduling event posts geographically, by interest group, or according to the relationship between two or more users 102a, 102b, 102c and 102d. Additionally, users 102a, 102b, 102c and 102d may download posted event scheduling data or use an application programming interface (API) to transfer posted event scheduling data to the calendars of the respective computing devices 101a, 101b, 101c and 101d.

FIG. 2 illustrates a schematic diagram illustrating an example embodiment of the schedule networking application 110 and scheduling event networking system 104. As shown, the networking application 110 and scheduling event networking system 104 can each include various components for performing the processes and features described herein. For example, as shown in FIG. 2, the networking application 110 may be installed on a client computing device (i.e., client computing devices 101a and 101b) and include a graphical user interface (“GUI”) manager 210, an input detector 211 and one or more application programming interfaces (“APIs”) 212. Additionally, as shown in FIG. 2, the scheduling event networking system 104 may include, but is not limited to, a user activity and communications manager 201, a payment manager 202, and data storage 203. The user activity and communications manager 201 and a payment manager 202 can include one or more processors. The data storage 203 can comprise a memory that storing instructions that when executed by the one or more processors cause the system to perform operations. The data storage 203 can store posted scheduling event data 204, user data 205, and node data 206. Although the disclosure herein describes the components 201-203, scheduling event networking system 104 may be combined into fewer components, such as into a single component, or divided into more components as may serve one or more embodiment.

Each of the components 210-212 of the schedule networking application 110 and the components 201-203 of the scheduling event networking system 104 can be implemented using a computing device including at least one processor executing instructions that cause the processes described herein. In some embodiments, the components 201-203 of the schedule networking application 110 and/or components 201-203 of the schedule event networking system 104 can all be implemented by a single server device, or across multiple server devices. Additionally, or alternatively, a combination of one or more server devices and one or more client devices can implement the components 210-212 of the schedule networking application 110 and the components 201-203 can comprise hardware, such as a special-purpose processing device to perform a certain function. Additionally, or alternatively, the components 201-203 can comprise a combination of computer-executable instructions and hardware.

In one or more embodiments, the schedule networking application 110 can be a native application installed on the client computing device 101a, and/or 101b. For example, schedule networking app 110 may be a mobile application that installs and runs on a mobile device, such as a smart phone or tablet. Alternatively, the schedule networking application 110 can be a desktop application, widget, or other form of a native computer program. Alternatively, the schedule networking application 110 may be a remote application that the client computing device 101a, and/or 101b accesses. For example, the schedule networking app 110 may be a web application that is executed within a web browser of the client computing device 101a, 101b. Additionally, in at least one embodiment, the schedule networking app 110 may exist on the client computing device 101a and/or 101b.

As mentioned above, and as shown in FIG. 2, the social networking application 110 can include a GUI manager 210. The GUI manager 210 can provide, manage, and/or control a graphical user interface (or simply “user interface”) that allows a user to compose, view, and send social media posts and electronic messages. For example, the GUI manager 210 can provide a user interface that facilitates the display of a user's wall. Likewise, the GUI manager 210 can provide a user interface that displays one or more scheduling updates received by a schedule network user.

More specifically, the GUI manager 210 can facilitate the display of a user interface (e.g., by way of a display device associated with the client computing device 101a, 101b). For example, the GUI manager 210 may compose the user interface of a plurality of graphical components, objects, and/or elements that allow a user to compose, send and/or receive event schedule updates. More specifically, the GUI manager 210 may direct the client computing device 101a, 101b to display a group of graphical components, objects and/or elements that enable a user to view event scheduling information. In addition, the GUI manager 210 may direct the client computing device 101a, 101b to display one or more graphical objects, controls, or elements that facilitate user input for composing and sending scheduling event updates to the scheduling network application 110. For example, the GUI manager 210 can provide one or more user interfaces that allow a user to input one or more types of content into an event schedule or calendar. As used herein, “content” refers to any data or information to be included as part of scheduling event information. For example, the term “content” will be used herein to generally describe event dates, times, location information, images, digital media files, payment information, reservation information, links to virtual events, organization information, or any other data that can be included as part of scheduling event data.

In addition, the GUI manager 210 can receive instructions or communications from one or more components of the schedule network application 110 to display updated scheduling event content. The GUI manager 210 can add, remove, and/or update various other selectable elements or controls within the certain event schedule content. For example, the GUI manager 210 can provide a user interface that includes a keyboard. A user can interact with the keyboard using one or more touch gestures to select text to be included in an event scheduling post. In addition to text, the interface, including the keyboard interface, can facilitate the input of various other characters, symbols, icons, or other character information. Additionally, the GUI manager 210 can provide and transition between two or more graphical user interfaces.

In one embodiment, the GUI manager 210 can provide event scheduling content from a certain user or organization, for example 102a, while also providing a link to the event scheduling content of a second/networked user or organization, for example, 102b. In response to selecting the link of the event schedule content of the second user or organization, for example 102b, the GUI manager 210 can then display a wall of scheduling event data provided by user or organization 102b.

As further illustrated in FIG. 2, the schedule networking application 110 can include a user input detector 211. In one or more embodiments, the user input detector 211 can detect, receive, and/or facilitate user input in any suitable manner. In some examples, the user input detector 211 can detect one or more user interactions with respect to the user interface. As referred to herein, a “user interaction” means a single interaction, or combination of interactions, received from a user by way of one or more devices. For example, user input detector 211 can detect a user interaction from a keyboard, mouse, touch pad, touch screen, and/or any other input device. In the event the client computing device 101a, 101b includes a touch screen, the user input detector 211 can detect one or more touch gestures, such as taps or swipes, from the user that forms the user interaction. The user input detector 211 may additionally, or alternatively, receive data representative of a user interaction. For example, the input detector 211 may receive one or more commands from the user, and/or any other suitable user input. The user input detector 211 may receive input data from one or more components of the schedule networking application 110, from the storage on the client computing device 101a, 101b, or from one or more remote locations, such as the scheduling event networking system 104.

The schedule networking application 110 can perform one or more functions in response to the user input detector 211 detecting user input and/or receiving other data. Generally, a user can control, navigate within, and otherwise use the schedule networking application 110 by providing one or more user inputs that the user input detector 211 can detect. For example, in response to the user input detector 211 detecting user input, one or more components of the schedule networking application 110 allow a user to select and navigate through schedule or calendar events from one or more networked users or organizations.

In one or more embodiments, in response to the user input detector 211 detecting one or more user inputs, the schedule networking application 110 can allow the user to create a payment to send to one or more other users. For example, a user wanting to send a payment can interact with a purchase control provided on a menu within a user interface. Upon detecting the user interaction with the purchase control, the schedule networking application 110 can provide a user interface for creating a payment. Therefore, in response to the user input detector 211 detecting one or more user inputs, the schedule networking application 110 can allow a user to create a customized payment that defines a payment to be sent to another user.

The schedule networking application 110 can also include one or more APIs 212 to perform functions, procedures, and methods to interact with the operating systems of client computing devices 101a, 101b. For example, in an embodiment, an API 212 can include a function to synchronize scheduling event information from the scheduling event networking system 104 with client computing device 101a, 101b calendar. Furthermore, in some embodiments, an API 212 can include a function to provide push notifications of schedule and calendar content to the user of the system 100.

The scheduling event networking system 104 can also include a user activity and communication manager 201. The user activity and communication manager 201 can monitor scheduling network event activity information received from the schedule networking application 110 on the client computing devices 101a, 101b. For example, the user activity and communications manager 201 can receive scheduling event information associated with a user input detector 211 of the schedule networking application 110. In some embodiments, a user can submit an update to an organizational calendar event or add an event to an organizational calendar. In some embodiments, the user activity and communications manager 201 can receive a request from a user's schedule networking application 110 to request that the user's organizational schedule or calendar to be linked under the event calendar grouping of schedules and calendars created by a different user. In response to the request, the user activity and communications manager 201 can relay the request to the second user's schedule networking application 110. The user activity and communications manager can instruct the GUI manager 210 of the second user's schedule networking application 110 to transition to a new graphical user interface that indicates the user-to-user request to link organizational calendars.

In one or more embodiments, the scheduling event networking system 104 can also include a payment manager 202, which can facilitate sending and receiving payments between users. The payment may be related to attending an event of an organization or entity. In some embodiments, the payment manager 202 can also send invoices to one or more users. As shown in FIG. 2, the scheduling event networking system 104 can also include a data storage 203. The data storage 203 can include posted scheduling event data 204, user data 205, and node data 206. In one or more embodiments, the posted scheduling event data 204 can include data representative of event content such as event dates, times, location information, images, digital media files, payment information, reservation information, organization information, or any other data that can be included as part of scheduling event data. In one or more embodiments, the user activity and communications manager 201 and payment manager 202 of the scheduling event networking system 104 can perform various functions associated with structured data associated with a particular posted schedule or a specific event with a schedule. In one or more embodiments, the data storage 203 stores the structured data as node data and edge information. For example, the data storage 203 may store nodes and edges in a network graph, where each edge connects two nodes, and one node can be connected via edges to one or more additional nodes.

A node may comprise a plurality of user nodes. A user node of a network graph may correspond to and include and include user data 205. A user may be an individual (human user), an entity (e.g., an enterprise, business, or third-party application), or a group (e.g., of individuals or entities) associated with one or more schedules of events. A user node corresponding to a user may comprise information provided by the user (e.g., user data 205) and information gathered by various systems, including the scheduling event networking system 104. The user data 205 may include the user's schedule and event content, profile logo or picture, city of residence, contact information, preferences, interests, and other demographic data to be included in the user node.

Each user node of the network graph may have a corresponding web page (typically known as a “profile page”). For example, the scheduling event networking system 104 can access a user node corresponding to the user and construct a profile page including the user's location, contact information, and other information associated with the user. A profile page may include all or a portion of the information stored within a user's node based on one or more privacy settings or other configurable settings. Additionally, or alternatively, a node may include a plurality of schedule event nodes related to schedule of event content. A schedule event node can include any suitable information associated with a schedule of events or individual events within a schedule of events. For example, a schedule event node can include a name of a schedule of events, a description of the schedule of events, a description of an individual event, an identification of one or more advertisers that sponsor an event or plurality of events, details of an event, cost of an event, an identification of the user that posted a schedule of events, images related to an event, videos related to an event, a URL address for the web site associated with the event, recommendations or reviews associated with an event, or any other information associated with a schedule of events or an individual event within a schedule of events. Similar to user nodes, each schedule event node of the network graph may correspond to a web page or profile page where users can access the corresponding content. For example, the scheduling event networking system 104 can access a schedule event node corresponding to a particular event and construct a profile page viewable by a browser or a mobile application including event information from the schedule event node.

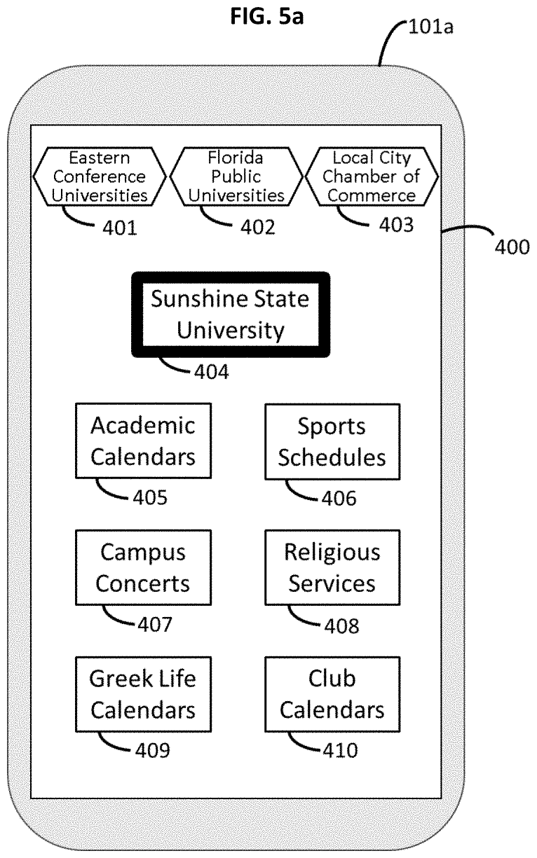

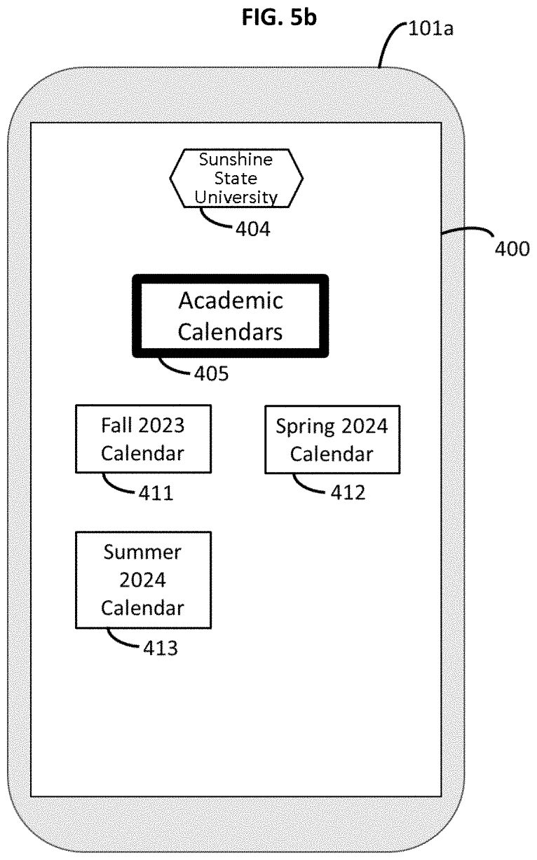

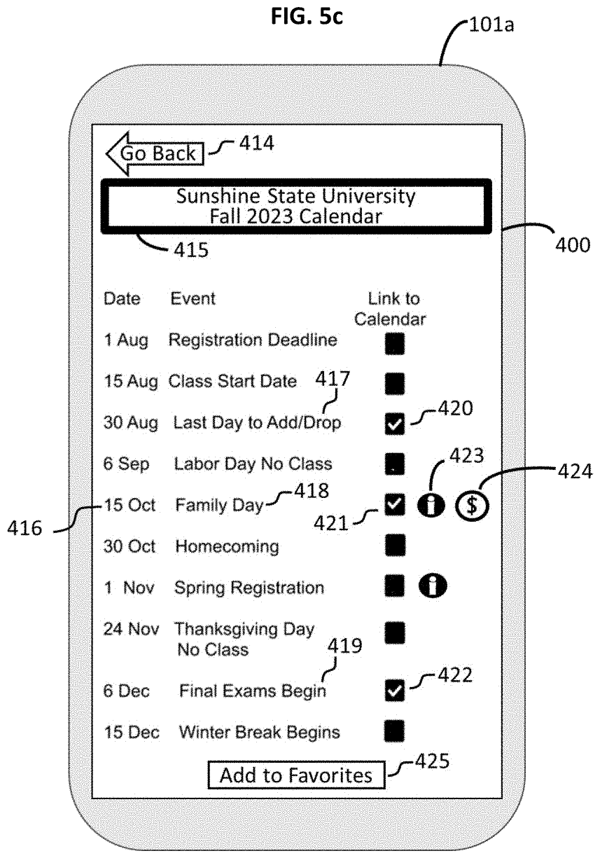

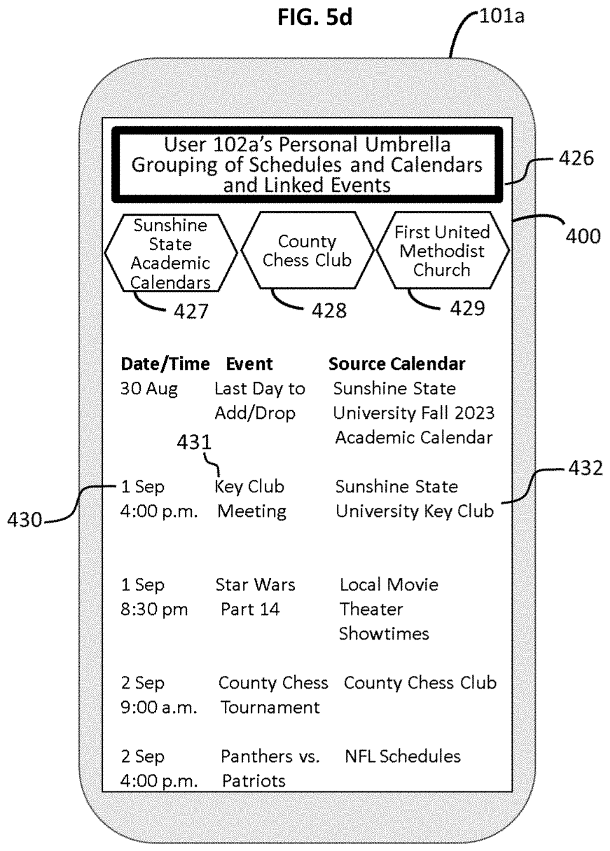

In one or more embodiments, relationships between users may be stored in data storage 203, which reflect the request of one or more users to associate and link a schedule of events with a separate schedule of events or an umbrella grouping of schedules and calendars controlled by the same user or a different user. For example, linked schedules and calendars of events from the same or different entities can be linked under thematic umbrellas that are built from user interactions and saved in data storage 203. Additionally, or alternatively, a user that has or has not posted a schedule of events or event content may utilize the schedule networking application 110 on a client computing device 101 to call up from the scheduling event networking system 104 a schedule of events of a user that has posted a schedule of events and, additionally or alternatively, an associated umbrella grouping of schedules and calendars of events from one or a plurality of users, which is stored within data storage 203. Additionally, or alternatively, a user that has or has not posted schedule event content may utilize schedule networking application 110 to personalize preferences of saved schedules of events or networked umbrella groupings of schedules and calendar events which are stored as user data 205, as discussed later with reference to FIG. 5d.

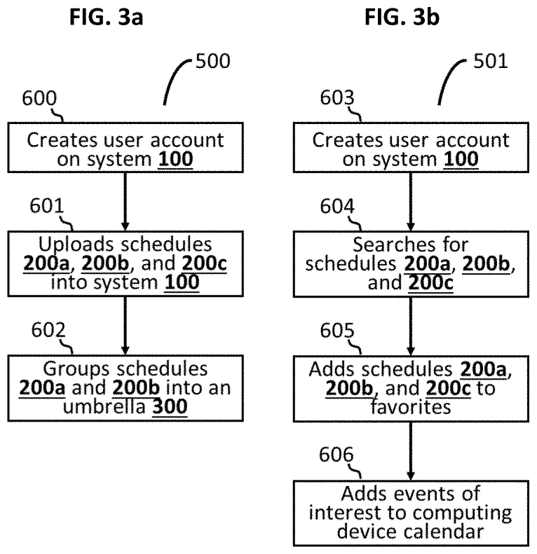

As discussed, FIGS. 1 and 2 describe a system and method for users to access a networked plurality of event schedules posted to the system by a plurality of users. In another aspect, FIGS. 3a and 3b illustrate an example of the upload and retrieval processes of schedule event content. Specifically, FIGS. 3a and 3b illustrate the process diagram of one or more embodiments of processes implemented by the system 100 discussed above. Consistent with system 100, FIG. 3a illustrates the user upload process 500, in which user 102a utilizes the schedule networking application 110a on client computing device 101a and user 102a is acting as an entity that creates a user account and creates three schedules of events 200a, 200b and 200c to be posted on the schedule event networking system 104. Furthermore, FIG. 3a illustrates that user 102a determines that schedules of events 200a and 200b are to be organized in a grouping on user 102a's wall, creating an umbrella grouping of schedules 300 which other users of the system 100 can observe and reference. Each calendar or schedule of events and umbrella grouping of calendars and schedules can be assigned a “handle” or unique identifier to assist users of the system in searching, sharing, marketing, authentication, grouping, organizing, referencing and the prevention of pretexting. As shown in FIG. 3a, for example, user 102a chooses not to group schedule of events 200c with schedule of events 200a and 200b. Additionally, FIG. 3b illustrates the user retrieval process 501, in which the user 102b utilizes the schedule networking application 110b on client computing device 101b to view schedules of events 200a, 200b, and 200c, which are posted to the system 100 by user 102a. FIG. 3b also illustrates an embodiment of the system 100, in which user 102b adds schedule 200c and umbrella grouping of schedules and calendars 300 to user 102b's favorites, for easy retrieval in subsequent interactions with the system 100. Furthermore, FIG. 3b illustrates an embodiment of the system 100, in which user 102b adds individual events to user 102b's personal calendar on client computing device 101b.

In another aspect, FIG. 3a illustrates the steps of a user upload process 500. The illustrated upload process 500 begins with a user 102a utilizing schedule networking application 110a on client computing device 101a to establish an account in the system 100 (step 600), which would constitute a one-time step. The schedule networking application 110a can connect to the network using various communications means available to the client computing device 101a (including, but not limited to CMDA, GPRS, GSM, WiFi, Bluetooth, and the like) to provide access to the network 103. The scheduling event networking system 104 may utilize the user activity and communication manager 201 to communicate with the schedule networking application 110a and to direct user 102a's demographic data and account credentials into user data 205 of data storage 203. After the user account is established, user 102a may utilize the schedule networking application 110a to upload or create a schedule of events 200a (step 601). In some embodiments, the schedule networking application 110a can provide prompts to direct the data entry process, ensuring that content entry fields are completed, which can be used to categorize and catalog the schedule of calendar of events for facilitating searches. Additionally, in an embodiment, the schedule networking application 110a may include a function that allows user 102a to upload schedule of event data using entry fields, a scanned sheet, diverse applications, or computer programs. Additionally or alternatively, plug-in functions in a user's third party program or application such as Excel, Outlook, Google Calendars, or Yahoo Calendars can facilitate the upload or schedule or calendar event data to the system 100. To complete step 601, user 102a may repeat the process to upload or create schedule of events 200b and 200c. In an embodiment, user 102a may utilize a function of the schedule networking application 110a to create a grouping or umbrella of schedules of events based on an organization structure determined by user 110a (e.g., by theme, season, time period) (step 602). For example, in some embodiments, user 110a may group schedules of events 200a and 200b into a grouping or umbrella 300.

In an aspect, FIG. 3b illustrates the steps of a user retrieval process 501, for user 102b. Similar to process 500, the illustrated user retrieval process 501 begins with a user 102b utilizing schedule networking application 110b on client computing device 101b to establish an account in the system 100 (step 603), which would constitute a one-time step. Likewise, similar to process 500, schedule networking application 110b can connect to the network using various communications means available to the client computing device 101b (including, but not limited to CMDA, GPRS, GSM, WiFi, Bluetooth, and the like) to provide access to the network 103. In an aspect, based on field entry data provided by user 102b during step 603, which could be for example, entries for location of residence, interests, or organization associations, the system 100 could provide suggested schedules and calendars of potential interest to user 102b. After the user account is established, user 102b may utilize the schedule networking application 110b to search for schedules of interest residing in scheduling event networking system 104 using, for example, key word searches, Boolean searches, or filter searches (step 604). Unique handles or identifiers assigned to each schedule or calendar of interest could assist users of the system in searching. Once schedules of interests are identified, for example schedules 200a, 200b, and 200c, user 102b may, through a user interaction with schedule networking application 110b, add schedules 200a, 200b, and 200c to stored favorites on user 102b's schedule networking application 110b (step 605). Furthermore, user 102b may, through a user interaction with schedule networking application 110b, add selected events of interest to user 102b's personal calendar on client computing device 101b. This can be done by using API's 212 to execute a command from the schedule networking application 110b to the computing device 101b's operating system (step 606).

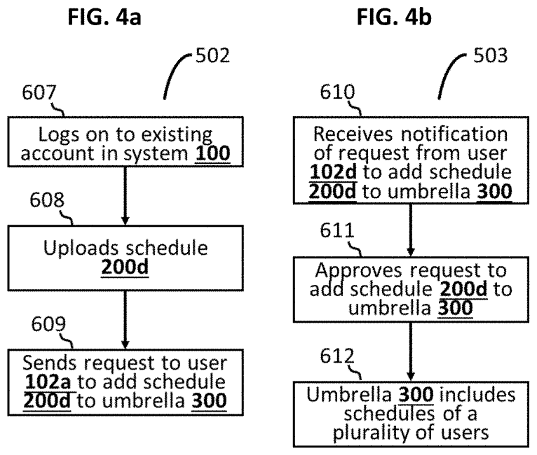

In another aspect, FIGS. 4a and 4b illustrate the steps of a user-to-user request process to jointly network schedules of events (process 502). The illustrated process 502 begins with a user 102d utilizing schedule networking application 110d on client computing device 101d to log into user 102d's account of the system 100, based on previously established credentials (step 607). User 102d may then utilize the schedule networking application 110d to upload or create a schedule of events 200d (step 608). Furthermore, user 102d may, through a user interaction with schedule networking application 110d, send a request through scheduling event networking system 104 to user 102a, requesting that schedule of events 200d be grouped with user 102a's umbrella grouping of schedules and calendars 300 (step 609). FIG. 4b illustrates an embodiment of a user-to-user response to a request process to network schedules of events (process 503). The illustrated process 503 begins when user 102a receives a notification of the request from user 102d to add schedule 200d to user 102a's umbrella grouping of schedules and calendars 300, which includes schedules of events 200a and 200b (step 610). The request can be sent from the schedule networking application 110d installed on client computing device 101d. User activity and communication manager 201 may relay the request to user schedule networking application 110a via scheduling event networking system 104, which may in turn use GUI manager 210 and APIs 212 to generate a text, update, push notification, signal, or some other form of a notification of the request on client computing device 101a. Through a user interaction utilizing schedule networking application 110a, user 102a may approve user 102d's request to add schedule 200d to user 102a's umbrella of schedules of events 300 (step 611) (likewise, user 102a could use the system 100 to deny user 102d's request). As a result of user 102a's approval, schedules of events 200a, 200b, and 200d are grouped into a single umbrella grouping of schedules and calendars 300, which is searchable for a plurality of users that utilize the system 100 (step 612).

In another aspect, FIGS. 5a-5c illustrate embodiments of various views of graphical user interfaces (“GUIs”), which may allow a user to interact with a collection of display elements for a variety of purposes for the functions of the system 100. FIGS. 5a-5c are specifically views of GUIs provided on client computing device 101a utilizing schedule networking application 110a, interacting with scheduling event networking system 104. In some embodiments, a client computing device can implement part of the system 100. For example, FIG. 5a illustrates a client computing device 101a of user 102a, who is using the system 100 to access a university academic year calendar and then to add specific events from said calendar to user 102a's personal client computing device calendar. As illustrated, the client computing device 101a is a handheld device, such as a mobile phone device. As used herein, the term “handheld device” refers to a device sized and configured to be operated in the hand of a user, such as a mobile smartphone. In addition, alternative examples, however, however, any other suitable computing device, such as, but not limited to, a tablet device, laptop, or desktop computer, and/or any other suitable computing device can perform one or more of the processes and/or operations described below.

As illustrated in FIG. 5a, the touch screen display 400 of client computing device 101a could display, in one or more embodiments, a network of schedules, calendars, umbrella groupings of schedules and calendars, provided by GUI manager 210 installed thereon. In the example, the GUI manager 210 provides a visual display of schedules, calendars, and umbrella groupings of schedules and calendars associated with a fictitious university in the state of Florida, named “Sunshine State University.” In FIG. 5a, the embodiment includes the umbrella grouping of schedules and calendars named Sunshine State University, 404, which in an embodiment may be highlighted or centered as the schedule, calendar, umbrella grouping of schedules and calendars of interest as selected by the user, navigating the schedule networking application 110a. Additionally, in the example illustrated in FIG. 5a, a different user that created umbrella grouping of schedules and calendars 404, created and linked additional umbrella groupings of schedules and calendars, named “Academic Calendars” 405, “Sports Schedules” 406, “Campus Concerts” 407, “Religious Services” 408, “Greek Life” 409, and “Club Calendars” 410. The process of creating and linking schedules, calendars, and umbrella groupings of schedules and calendars can be in accordance with processes 502 and 503, as was illustrated in FIGS. 3a, 4a and 4b. In the example illustrated in FIG. 5a, umbrella grouping of schedules and calendars 404 is comprised of six additional umbrella groupings of schedules and calendars, however an umbrella grouping of schedules and calendars in system 100 could be comprised of any plurality and combination of schedules, calendars, and umbrella groupings of schedules and calendars. Additionally, FIG. 5a illustrates how in some embodiments the GUI manager 210 may also display the umbrella groupings of schedules and calendars, to which the schedules, calendars, and umbrella groupings of schedules and calendars are part of, if any. As illustrated in FIG. 5a, the umbrella grouping of schedules and calendars 404, “Sunshine State University,” is part of umbrella grouping of schedules and calendars “Eastern Conference Universities” 401, “Florida Public Universities” 402, and “Local City Chamber of Commerce” 403. While FIG. 5a illustrates only three umbrella grouping of schedules and calendars (401, 402, and 403), a schedule, calendar, or umbrella grouping of schedules and calendars could be linked and part of any plurality of umbrella groupings of schedules and calendars.

In another aspect, FIG. 5b illustrates the results of a user interaction if the user selected the umbrella grouping of schedules and calendars named “Academic Calendars” 405, when the touch screen display 400 of client computing device 101a was configured as depicted in FIG. 5a. The GUI manager 210 provides a visual display of the calendars linked under “Academic Calendars” 405, namely, “Fall 2023 Calendar” 411, “Spring 2024 Calendar” 412, and “Summer 2024 Calendar” 413. Furthermore, FIG. 5b illustrates that umbrella grouping of schedules and calendars named “Academic Calendars” 405 is a part of umbrella grouping of schedules and calendars “Sunshine State University” 404.

FIG. 5c shows an embodiment of an example illustration of the results of a user interaction if the user selected the calendar named “Fall 2023 Calendar” 411, when the touch screen display 400 of client computing device 101a was configured as depicted in FIG. 5b. Once the selection is made by the user, the GUI manager 210 provides a visual display of the calendar of interest, in this example, the Sunshine State University Fall 2023 Academic Calendar, as illustrated in FIG. 5c. If the user desired to go back to the configuration as depicted in FIG. 5b, the user could touch the “Go Back” icon 414. In an aspect, as depicted in FIG. 5c, the GUI manager 210 could provide a visual display of the schedule or calendar of interest, to include a header of the schedule of calendar's title 415. Additionally, or alternatively, the visual display could depict the event information to include the event's date 416 and the name of the event 417. The visual display could also provide an option for the user to link the event to the user's calendar.

In the example illustrated in FIG. 5c, the user chooses to link the Sunshine State University's events named “Last Day to Add/Drop” (417), “Family Day” (418), and “Final Exams Begin” (419) to the user's personal calendar, by touching boxes 420, 421, and 422, respectively. In an embodiment, when a user opts to link events to the user's personal calendar, such as “Last Day to Add/Drop” (417), “Family Day” (418), and “Final Exams Begin” (419) by touching boxes 420, 421, and 422, respectively, APIs 212 built within the schedule networking application 110 may send the event data to the personal calendar of the user (e.g. an iPhone calendar, an android calendar, a Google calendar, an Outlook calendar, or other personal calendar systems), depending on the user's chosen settings. In an aspect, the visual display presented by the GUI manager 210 could present an optional “more information” icon for any plurality of events depending on the preferences of the user that created the particular schedule or calendar. In the example, as illustrated by FIG. 5c, icon 423, could serve as a link to a web page that provides further information or content about the “Family Day” event (418) and possibly location details and registration details, as determined by the user that created the calendar. In the example, as illustrated by FIG. 5c, icon 424, could serve as a link to a web page that provides a method for users of system 100 to pay for the “Family Day” event (418). Furthermore, in an embodiment, users of the system 100 can build a personal umbrella grouping or groupings of schedules and calendars from the system 100, whereby the user can easily access the schedules and calendars of interests selected as favorites and the user may receive updates of event changes if the owning users of said schedules or calendars perform updates. Relatedly, in an embodiment, the visual display presented by the GUI manager 210 could include an icon (425) that allows the user of system 100, to add user selected schedules and calendars to the user's favorites, so that the user can maintain a personal umbrella grouping of selected schedules and calendars for easy access to the favorite calendars later.

In an embodiment, FIG. 5d depicts an example embodiment of a user 102a's touch screen display 400 of client computing device 101a. Specifically, FIG. 5d shows how the schedule networking application 110 could present a “home” page, in which the user's name banner 426 could identify the page. Furthermore, in an aspect, the user's home page could include a scrollable set of the calendars, schedules, and umbrella groupings of schedules and calendars that the user has previously selected as favorites to follow. In the example embodiment illustrated in FIG. 5d, the user's screen indicates that the user's favorites include the umbrella grouping of schedules and calendars entitled “Sunshine State Academic Calendars” 427, the umbrella grouping of schedules and calendars entitled “County Chess Club” 428, and the umbrella grouping of schedules and calendars entitled “First United Methodist Church” 429. Additionally, in some embodiments, the home page could include the individual events that the user selects to track in layered, consolidated list, which could include the date and time (430), the name of the event that could also serve as a link back to the source calendar event entry (431) and a link back to the source calendar (432). In another aspect, APIs 212 built within the schedule networking application 110 could allow each or all of the events listed to be exported to the user's personal calendar on the client computing device 101a or to a third party calendar (e.g. an iPhone calendar, an android calendar, a Google calendar, an Outlook calendar, or other personal calendar systems), depending on the user's chosen settings.

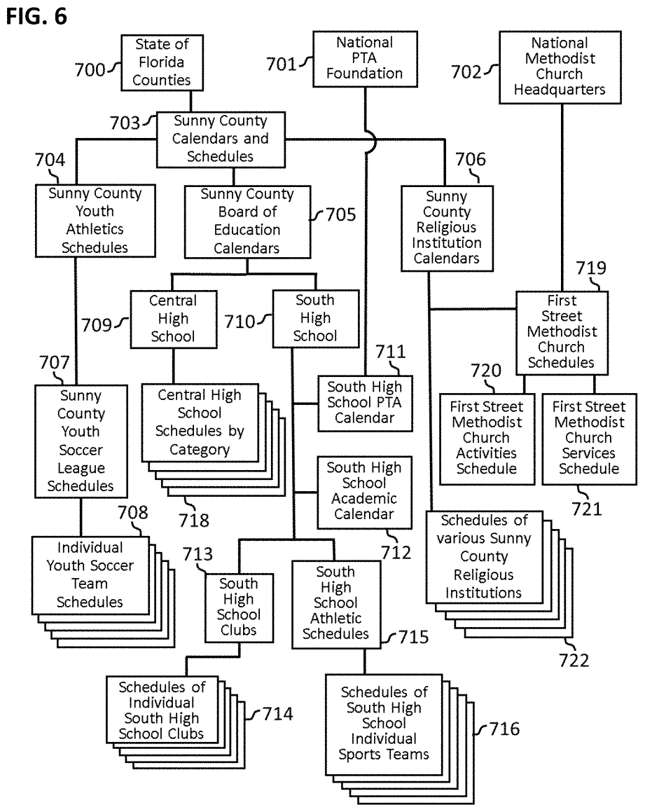

FIG. 6 illustrates how in some embodiments, system 100 can unite otherwise unlinked schedules and calendars created by entities into a network and serve a repository for a plurality of schedules and calendars which users of the system can easily access utilizing schedule networking application 110. Through the processes described above, users of the system, who create or upload schedules calendars to the system 100, can send requests to any plurality of other users of the system 100 who create or upload schedules and calendars to unite schedules and calendars into umbrella groupings that can be useful to users navigating the system 100. In another aspect, FIG. 6 illustrates an example embodiment of a network of schedules and calendars. FIG. 6 depicts an example embodiment of one of any plurality of networks that could be created through user-to-user interactions.

The example illustrated in FIG. 6 includes linked umbrella groupings of schedules and calendars and associated schedules and calendars. For example, an umbrella grouping of schedules and calendars created by a user titled, “State of Florida Counties” (700) includes additional umbrella groupings of schedules and calendars for each of the counties of Florida to include the umbrella grouping of schedules and calendars called “Sunny County Calendars and Schedules” (703). Umbrella grouping of calendars “Sunny County Calendars and Schedules” (703) includes three additional umbrella groupings of schedules and calendars called “Sunny County Youth Athletic Schedules” (704) “Sunny County Board of Education Calendars” (705), and “Sunny County Religious Institution Calendars” (706). Umbrella grouping of schedules and calendars “Sunny County Youth Athletic Schedules” (704) includes umbrella groupings of schedules for various youth sports, to include the umbrella groupings of schedules called “Sunny County Youth Soccer League Schedules” (707). Included within umbrella groupings of schedules “Sunny County Youth Soccer League Schedules” (707), are a plurality of individual youth soccer team schedules (708), which could each be publicly or privately accessible to users depending on the desired settings of the creators of each schedule. Umbrella grouping of schedules and calendars “Sunny County Board of Education Calendars” (705) includes a plurality of umbrella groupings of schedules and calendars for each school in the school system to include “Central High School” (709) and “South High School” (710). Umbrella grouping of schedules and calendars “South High School” (710) includes two calendars called “South High School PTA” (711) and “South High School Academic Calendar” (712). Umbrella grouping of schedules and calendars “South High School” (710) also includes two additional umbrella grouping of schedules and calendars called “South High School Clubs” (713) and “South High School Athletic Schedules” (715). As is depicted in the example embodiment illustrated by FIG. 6, calendar “South High School PTA” (711) is included in both umbrella groupings of calendars and schedules “South High School” (710) and “National PTA Foundation” (701). Umbrella grouping of schedules and calendars “South High School Clubs” (713) includes a plurality of schedules of individual South High School clubs (714), each of which can be set for public or private access depending on the desired settings of the respective schedules' creators. Furthermore, umbrella grouping of schedules and calendars “South High School Athletic Schedules” (715) includes the schedules of South High School individual sports teams (716), each of which can be set for public or private access depending on the desired settings of the respective schedules' creators. Similar to the umbrella grouping of schedules and calendars “South High School” (710), umbrella grouping of schedules and calendars “Central High School” (709), includes various schedules by category (718).

Additionally, the network of schedules, calendars, and umbrella groupings of schedules and calendars FIG. 6 includes an umbrella grouping of schedules and calendars called “Sunny County Religious Institution Calendars” (706). Umbrella grouping of schedules and calendars “Sunny County Religious Institution Calendars” (706) can comprise the schedules of various Sunny County Religious Institutions, including the umbrella grouping of schedules and calendars called “First Street Methodist Church Schedules” (719). Umbrella grouping of schedules and calendars “First Street Methodist Church Schedules” (719) can include two schedules entitled “First Street Methodist Church Activities Schedule” (720) and “First Street Methodist Church Services Schedules” (721), each of which can be set for public or private access depending on the desired settings of the respective schedules' creators. Umbrella grouping of schedules and calendars “First Street Methodist Church Schedules” (719) is included in both umbrella of schedules and calendars “Sunny County Religious Institution Calendars” (706) and the umbrella of schedules and calendars called “National Methodist Church Headquarters” (702), the latter of which may include the umbrella groupings of Methodist churches around the nation.

These and other modifications and variations to the present subject matter may be practiced by those of ordinary skill in the art, without departing from the spirit and scope of the present subject matter, which is more particularly set forth herein above. In addition, it should be understood the aspects of the various embodiments may be interchanged both in whole and in part. Furthermore, those of ordinary skill in the art will appreciate that the foregoing description is by way of example only, and is not intended to limit the present subject matter.

1. Any and all systems, methods, and mobile applications for event, calendar and schedule networking, management, and display as shown and/or described expressly or by implication in the information provided herewith, including but not limited to features that may be apparent and/or understood by those of skill in the art.

2. A method of a managing, networking, and presenting calendars, schedules and events, the method comprising:
uploading from one or more computing devices of one or more users at least one of calendars of events, schedules of events or individual events to a scheduling event networking system;
grouping two or more calendars of events, schedules of events or individual events into one or more umbrella groupings based on instructions received from one or more computing devices of one or more users; and
displaying on one or more computing devices of one or more users a layered network of one or more of the calendars of events, schedules of events, individual events, or umbrella groupings on the scheduling event networking system based on user preferences.

3. The method according to claim 2, wherein the step of grouping two or more calendars of events, schedules of events or individual events comprises grouping two or more calendars of events, schedules of events or individual events uploaded from a computing device of a first user into one or more umbrella groupings of the first user based on a request received from the computing device of the first user.

4. The method according to claim 3, wherein the step of grouping two or more calendars of events, schedules of events or individual events further comprises:
receiving at the scheduling event networking system a request from a computing device of a second user to group at least one of a calendar of events, a schedule of events or an individual event uploaded from the computing device of the second user to an umbrella grouping of the one or more umbrella groupings of the first user; and
presenting a notification on the computing device operated by the first user the request to add the calendar of events, the schedule of events or the individual event of the second user to the one or more umbrella groupings of the first user in a manner that the first user has a choice to accept or decline the request.

5. The method according to claim 4, further comprising adding the calendar of events, schedule of events or individual event of the second user to the one or more umbrella groupings of the first user upon acceptance of the request.

6. The method according to claim 2, further comprising grouping two or more calendar of events, schedule of events, individual events, or umbrella groupings into one or more umbrella groupings based on instructions received from one or more computing devices of one or more users.

7. The method according to claim 6, wherein the one or more umbrella groupings comprise thematically nested umbrella groupings for displaying on one or more computing devices of one or more users based on user preferences for efficient user awareness of linked and networked calendars of events, schedules of events, individual events, or umbrella groupings.

8. The method according to claim 2, further comprising assigning a unique identifier to each of the calendars of events, schedules of events, individual events, and umbrella groupings to assist one or more users in searching, sharing, marketing, authenticating, grouping, organizing, referencing, or preventing pretexting on the user's respective computing device.

9. The method according to claim 2, further comprising permitting calendars of events, schedules of events, individual events, or umbrella groupings to be exported to calendars of the computing devices of the one or more users.

10. A system of managing, networking, and presenting calendars, schedules and events, the system comprising:
a scheduling event networking system that comprises one or more processors and data storage that includes memory storing instructions that when executed by the one or more processors cause the system to perform operations comprising:
uploading from one or more computing devices of one or more users at least one of calendars of events, schedules of events or individual events to a scheduling event networking system;
grouping two or more calendars of events, schedules of events or individual events into one or more umbrella groupings based on instructions received from one or more computing devices of one or more users; and
displaying on one or more computing devices of one or more users a layered network of one or more of the calendars of events, schedules of events, individual events, or umbrella groupings on the scheduling event networking system based on user preferences.

11. The system according to claim 10, wherein the step of grouping two or more calendars of events, schedules of events or individual events comprises grouping two or more calendars of events, schedules of events or individual events uploaded from a computing device of a first user into one or more umbrella groupings of the first user based on a request received from the computing device of the first user.

12. The method according to claim 11, wherein the step of grouping two or more calendars of events, schedules of events or individual events further comprises:
receiving at the scheduling event networking system a request from a computing device of a second user to group at least one of a calendar of events, a schedule of events or an individual event uploaded from the computing device of the second user to an umbrella grouping of the one or more umbrella groupings of the first user; and
presenting a notification on the computing device operated by the first user the request to add the calendar of events, the schedule of events or the individual event of the second user to the one or more umbrella groupings of the first user in a manner that the first user has a choice to accept or decline the request.

13. The system according to claim 12, wherein the operations comprise adding the calendar of events, schedule of events or individual event of the second user to the one or more umbrella groupings of the first user upon acceptance of the request.

14. The system according to claim 10, wherein the operations comprise grouping two or more calendars of events, schedules of events, individual events, or umbrella groupings into one or more umbrella groupings based on instructions received from one or more computing devices of one or more users.

15. The system according to claim 14, wherein the one or more umbrella groupings comprise thematically nested umbrella groupings for displaying on one or more computing devices of one or more users based on user preferences for efficient user awareness of linked and networked calendars of events, schedules of events, individual events, or umbrella groupings.

16. The system according to claim 10, wherein the operations comprise assigning a unique identifier to each of the calendars of events, schedules of events, individual events, and umbrella groupings to assist one or more users in searching, sharing, marketing, authenticating, grouping, organizing, referencing, or preventing pretexting on the user's respective computing device.

17. The system according to claim 10, wherein the operations comprise permitting calendars of events, schedules of events, individual events, or umbrella groupings to be exported to calendars of the computing devices of the one or more users.

18. One or more non-transitory computer-readable media comprising instructions that when executed by one or more computing devices cause the one or more computing devices to perform operations comprising:
uploading from one or more computing devices of one or more users at least one of calendars of events, schedules of events or individual events to a scheduling event networking system;
grouping two or more calendars of events, schedules of events or individual events into one or more umbrella groupings based on instructions received from one or more computing devices of one or more users; and
displaying on one or more computing devices of one or more users a layered network of one or more of the calendars of events, schedules of events, individual events, or umbrella groupings on the scheduling event networking system based on user preferences.

19. The one or more non-transitory computer-readable media of claim 18, wherein the step of grouping two or more calendars of events, schedules of events or individual events comprises grouping two or more calendars of events, schedules of events or individual events uploaded from a computing device of a first user into one or more umbrella groupings of the first user based on a request received from the computing device of the first user.

20. The one or more non-transitory computer-readable media of claim 19, wherein the step of grouping two or more calendars of events, schedules of events or individual events further comprises:
receiving at the scheduling event networking system a request from a computing device of a second user to group at least one of a calendar of events, a schedule of events or an individual event uploaded from the computing device of the second user to an umbrella grouping of the one or more umbrella groupings of the first user; and
presenting a notification on the computing device operated by the first user the request to add the calendar of events, the schedule of events or the individual event of the second user to the one or more umbrella groupings of the first user in a manner that the first user has a choice to accept or decline the request.

21. The one or more non-transitory computer-readable media of claim 20, further comprising adding the calendar of events, schedule of events or individual event of the second user to the one or more umbrella groupings of the first user upon acceptance of the request.

22. The one or more non-transitory computer-readable media of claim 18, further comprising grouping two or more calendars of events, schedules of events, individual events, or umbrella groupings into one or more umbrella groupings based on instructions received from one or more computing devices of one or more users.

23. The one or more non-transitory computer-readable media of claim 22, wherein the one or more umbrella groupings comprise thematically nested umbrella groupings for displaying on one or more computing devices of one or more users based on user preferences for efficient user awareness of linked and networked calendars of events, schedules of events, individual events, or umbrella groupings.

24. The one or more non-transitory computer-readable media of claim 18, further comprising assigning a unique identifier to each of the calendars of events, schedules of events, individual events, and umbrella groupings to assist one or more users in searching, sharing, marketing, authenticating, grouping, organizing, referencing, or preventing pretexting on the user's respective computing device.

25. The one or more non-transitory computer-readable media of claim 18, further comprising permitting calendars of events, schedules of events, individual events, or umbrella groupings to be exported to calendars of the computing devices of the one or more users.
